(19) United States
(12) Patent Application Publication
(10) Pub. No.: US 2025/0214439 A1
(43) Pub. Date: Jul. 3, 2025

(54) DISPLAY DEVICE AND VEHICLE EQUIPPED WITH SAME

(71) Applicant: HYUNDAI MOBIS CO., LTD., Seoul (KR)

(72) Inventors: Hyun Jun AN, Gunpo-si (KR); Shin Jik LEE, Hwaseong-si (KR); Jun LEE, Yongin-si (KR); Kyung Hoon KIM, Seongnam-si (KR)

(73) Assignee: HYUNDAI MOBIS CO., LTD., Seoul (KR)

(21) Appl. No.: 18/773,161

(22) Filed: Jul. 15, 2024

(30) Foreign Application Priority Data
Dec. 28, 2023 (KR) 10-2023-0194168

(51) Int. Cl. B60K 35/53; B60K 35/22; G02B 27/01

(52) U.S. Cl. CPC B60K 35/53; B60K 35/22; G02B 27/0101; G02B 27/0149; G02B 27/0179; B60K 2360/21; B60K 2360/23; G02B 2027/0154; G02B 2027/0181

(57) ABSTRACT

A display device including a see-through area in a vehicle, a vehicle thereof, and display system thereof are provided. The display device includes a front display having display areas and located in front of a driver seat and a passenger seat of the vehicle, a drive module to adjust a position of the front display, and a see-through module adjacent to a front lower part of the front display when the front display is located at a lowest point. The see-through module includes a see-through panel to provide information to a driver and a passenger by transmitting light from a lower area of the front display.

### CROSS-REFERENCE TO RELATED APPLICATION(S)

This application claims the benefit under 35 USC § 119 of Korean Patent Application No. 10-2023-0194168, filed on Dec. 28, 2023, in the Korean Intellectual Property Office, the entire disclosure of which is hereby incorporated by reference for all purposes.

### BACKGROUND

### 1. Field

The present disclosure relates to a display device for providing a see-through area in a vehicle and vehicle equipped with the same.

### 2. Description of the Related Art

A center fascia display of a vehicle may display various visual information about the vehicle. Such a display device may also be installed on a dashboard of a vehicle disposed in front of a driver's seat and a front passenger seat, and provides various convenience information such as navigation, vehicle management and operation, Internet, and entertainment.

With the digitization of vehicles, various convenience information is being provided through diverse communication functions. For example, the location of a vehicle is checked remotely via the Internet or a smartphone, and nearby charging stations are discovered. In addition, all information on the current state of the vehicle is monitored in real time. For example, battery charging or pre-conditioning is capable of being easily activated with just a touch of a button. Moreover, intelligent driving assistance systems acquire information on road travel, thereby creating a more convenient driving environment for drivers.

Recently, display devices mounted on vehicles are becoming larger, and thus, there is a need for means to effectively display various convenience information.

Furthermore, there is an increasing demand for the manipulation and operation of display devices capable of providing more effective usability to drivers and passengers.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

Accordingly, the present disclosure is directed to a display device and vehicle equipped with the same that substantially obviate one or more problems due to limitations and disadvantages of the related art.

The present disclosure aims to provide a display device for effectively providing various convenience information by adjusting the height of a display depending on the position of a specific facial portion of a driver and vehicle equipped with the same.

The present disclosure aims to provide a display device for efficiently controlling the movement and tilting of a display through a drive module including a ball screw member and a link member and vehicle equipped with the same.

The present disclosure aims to provide a display device for organically controlling the movement of a display through a four-bar linkage structure involving four rotation points formed on a first link, a second link, and a support bracket and vehicle equipped with the same.

It will be appreciated by persons skilled in the art that the objects that could be achieved with the present disclosure are not limited to what has been particularly described hereinabove and the above and other objects that the present disclosure could achieve will be more clearly understood from the following detailed description.

In a general aspect of the disclosure, a display device including a see-through area for a vehicle, includes: a front display having a plurality of display areas and located in front of a driver seat and a passenger seat of the vehicle; a drive module configured to adjust a position of the front display; and a see-through module adjacent to a front lower part of the front display when the front display is located at a lowest point, wherein the see-through module comprises a see-through panel configured to provide information to a driver and a passenger by transmitting light from a lower area of the front display.

The see-through module may further include a rubber member coupled to a first end of the see-through panel, and the rubber member may be in contact with the front lower part of the front display and configured to block light from leaking through a gap between the see-through panel and the front lower part of the front display.

The see-through module may further include: a housing coupled to the see-through panel; and a reflector located inside the housing, positioned opposite the front lower part of the front display, and configured to reflect light transmitted from a lower area of the front display.

The reflector may include a reflective surface made of a thin metal film, the thin metal film including aluminum.

The drive module may be linked to a camera mounted on the vehicle, and configured to adjust the position of the front display based on a position of a specific facial portion of an occupant in the driver seat or the passenger seat, and provide driving force to the front display to enable the front display to rotate and move in a curved path.

The display device may further include: a support bracket coupled to a rear surface of the front display, and the drive module may include: a link member rotatably coupled to the support bracket; and a ball screw member connected to the link member and configured to move in a straight line and rotate the link member.

The support bracket may include: a first rotation protrusion formed on a first side thereof; and a second rotation protrusion formed on a second side thereof, and the link member may include: a first link into which the first rotation protrusion is inserted on a first side thereof, the first link comprising a first guide groove formed longitudinally; and a second link into which the second rotation protrusion is inserted on the first side thereof.

The drive module may include a fixed bracket formed to rotatably couple a second side of the first link and a second side of the second link, wherein the fixed bracket may include a guide plate into which the first rotation protrusion is inserted, and wherein a second guide groove configured to guide a curved movement of the support bracket may be formed on the guide plate.

The drive module may further include: a rotation shaft coupled to the second side of the first link; and a rotation plate extending from an outer peripheral surface of the rotation shaft and coupled to the ball screw member.

The position of the front display may include a height of the display.

The position of the specific facial portion of the occupant in the driver seat or the passenger seat may be detected by a camera.

In another general aspect of the disclosure, a vehicle includes: a vehicle body; a mounting portion located on the vehicle body; and a display device mounted on the mounting portion and configured to provide a see-through area, wherein the display device includes: a front display having a plurality of display areas and located in front of a driver seat and a passenger seat of the vehicle; a drive module configured to adjust a height of the front display; and a see-through module adjacent to a front lower part of the front display when the front display is located at a lowest point, and wherein the see-through module includes a see-through panel configured to provide information to a driver and a passenger by transmitting light from a lower area of the front display.

In yet another general aspect of the disclosure, a display system for a vehicle, includes: a front display having display areas and located in front of a driver seat and a passenger seat of the vehicle; a camera to detect a position of a specific facial portion of an occupant in the driver seat or the passenger seat; a drive module in communication with the camera configured to adjust a position of the front display; a see-through module including a reflector and a see-through panel, the see-through panel positioned adjacent to a front lower part of the front display when the front display is located at a lowest point, such that light from the lower area of the front display is reflected by the reflector and transmitted through the see-through panel to provide information to the occupant; and a processor configured to control the drive module to adjust the position of the front display based on the detection of the position of the specific facial portion of the occupant by the camera.

The processor is further configured to control the drive module to adjust the position of the front display to provide optimal viewing by the occupant.

The see-through module may be movable between a first position in which the see-through module is adjacent to the front lower part of the front display to reflect light from the lower part of the front display through the see-through panel, and a second position in which the see-through module is positioned away from the front lower part of the front display such that light from the lower part of the front display is not reflected through the see-through panel.

The additional scope of applicability of the present disclosure will become apparent from the detailed description below. However, various changes and modifications within the spirit and scope of the present disclosure will be apparent to those skilled in the art. Thus, specific embodiments including the detailed descriptions and preferred embodiments of the present disclosure are given by way of example only.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram illustrating a vehicle according to an embodiment of the present disclosure;

FIG. 2 is a perspective view of a display device according to an embodiment of the present disclosure;

FIG. 3 is a diagram for explaining a method of recognizing the position of a specific facial portion of a driver in a display device according to an embodiment of the present disclosure;

FIGS. 4 to 7 are diagrams for explaining a method of adjusting the height of a front display in a display device according to an embodiment of the present disclosure;

FIG. 8 is a diagram for explaining a method of detecting the height of a front display through a position detection sensor in a display device according to the embodiment of the present disclosure;

FIG. 9 is a diagram for explaining a method of controlling a display device according to an embodiment of the present disclosure;

FIGS. 10 and 11 are diagrams for explaining various embodiments of a display device control method according to the present disclosure;

FIG. 12 is a diagram illustrating a see-through module in a display device according to an embodiment of the present disclosure;

FIG. 13 is a diagram illustrating a see-through panel in a display device according to an embodiment of the present disclosure; and

FIG. 14 is a diagram illustrating information provided to a see-through panel in a display device according to an embodiment of the present disclosure.

### DETAILED DESCRIPTION

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, it will be understood that when an element is referred to as being “directly connected with” another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

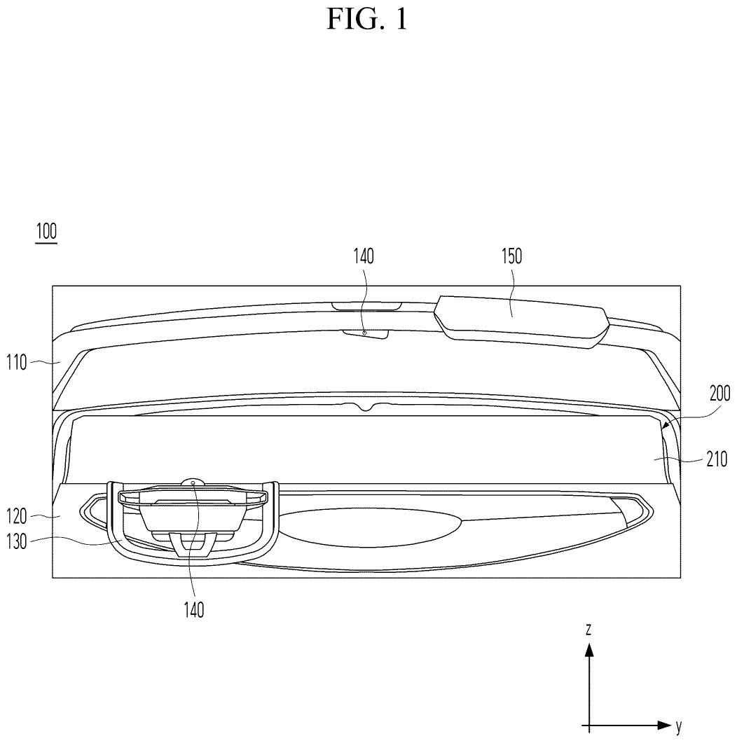

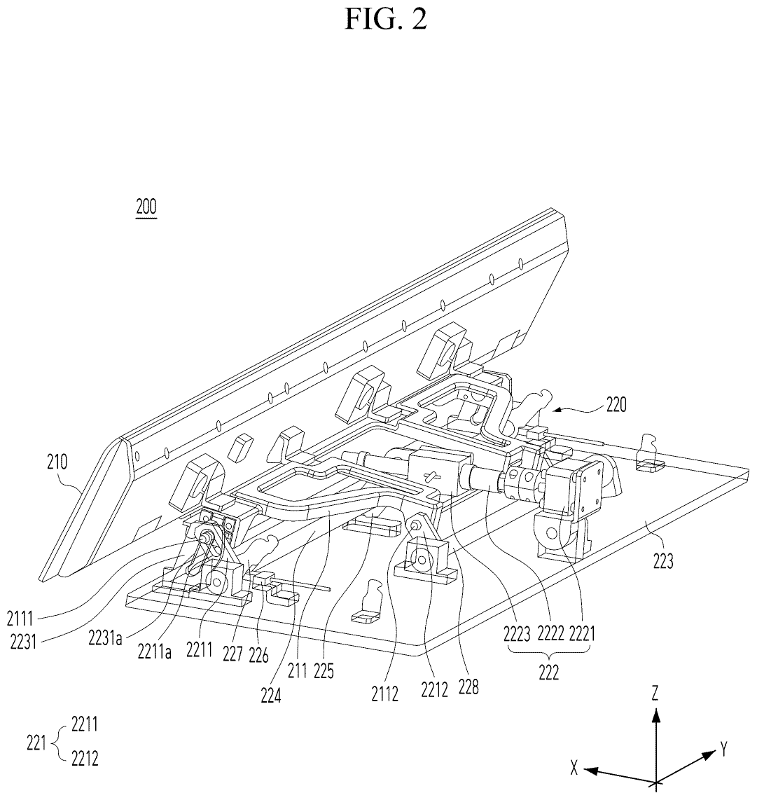

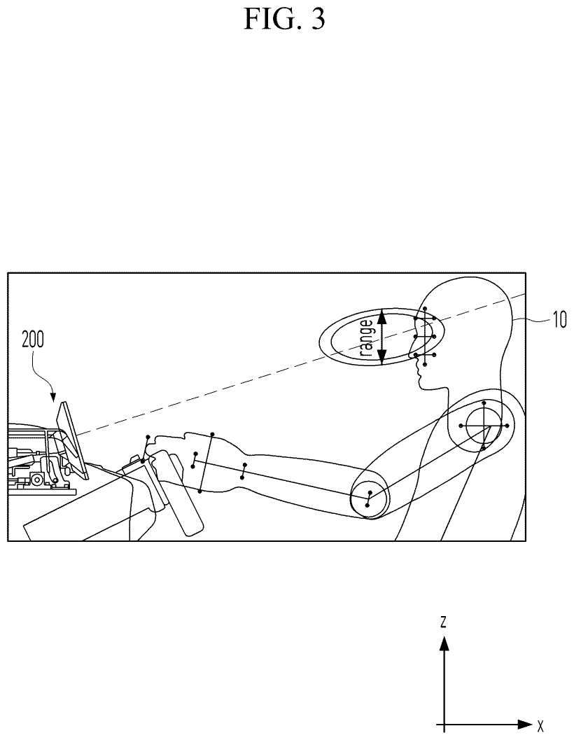

FIG. 1 is a diagram illustrating a vehicle 100 according to an embodiment of the present disclosure. FIG. 2 is a perspective view of a display device 200 according to an embodiment of the present disclosure. FIG. 3 is a diagram for explaining a method of recognizing the position of a specific facial portion of a driver 10 in a display device 200 according to an embodiment of the present disclosure.

Hereinafter, in describing the display device 200 according to the embodiment of the present disclosure, it is assumed that the front and rear direction is the x-axis direction, the left and right direction is the y-axis direction, and the up and down direction is the z-axis direction.

FIG. 1 is a diagram illustrating the vehicle 100 according to the embodiment of the present disclosure. Specifically, FIG. 1 shows the front of a driver seat and a front passenger seat inside the vehicle 100.

As shown in FIG. 1, the display device 200 may be mounted on a mounting portion 120 located on a vehicle body 110. The mounting portion 120 may include a dashboard positioned in front of the driver seat and front passenger seat. In addition, the display device 200 may include a front display 210 positioned in front of the driver seat and front passenger seat of the vehicle 100. As illustrated in FIG. 2, the display device 200 may include a drive module 220 for adjusting the height of the front display 210.

In addition, a steering wheel 130 may be positioned in front of the driver seat. The steering wheel 130 mounted on the vehicle 100 according to the embodiment of the present disclosure may include a D-shaped steering wheel 130 to secure a better view of the driver towards the front display 210. A camera 140 may be positioned on the top of the mounting portion 120 or vehicle body 110.

The camera 140 mounted on the vehicle 100 may play a role in recognizing the position of the specific facial portion of the driver. The drive module 220 is linked to the camera 140 and configured to adjust the height of the front display 210 depending on the position of the specific facial portion of the driver.

Referring to FIG. 3, the display device 200 according to the embodiment of the present disclosure may recognize the position of the specific facial portion (e.g., eyes or nose) of the driver 10 through the camera 140. In an embodiment, while the driver 10 is sitting on the seat, the position of the specific facial portion of the driver 10 may be recognized within a range shown in FIG. 3 based on a height value, which is a z-axis coordinate value.

Additionally, in the vehicle 100 according to the embodiment of the present disclosure, a passenger airbag 150 may be installed on an upper front portion of the passenger seat in response to enlargement of the display device 200 and adjustment of the height of the front display 210, which will be described later. Accordingly, the present disclosure may promote the safety of passengers as well as provide the display device 200 customized for the passengers.

FIG. 2 is a perspective view of a display device 200 according to an embodiment of the present disclosure.

The display device 200 according to the embodiment of the present disclosure may include a drive module 220 that is linked to a front display 210 positioned in front of a driver seat and a passenger seat of a vehicle 100 and a camera 140 mounted on the vehicle 100 and configured to adjust the height of the front display 210 depending on the position of a specific facial portion of a driver. The drive module 220 may provide driving force to the front display 210 to allow the front display 210 to rotate and move in a curved path.

A support bracket 211 may be coupled to the rear surface of the front display 210. The drive module 220 may include a link member 221 rotatably coupled to the support bracket 211. The drive module 220 may include a ball screw member 222 that is connected to the link member 221, moves in a straight line, and rotates the link member 221.

The support bracket 211 may include a first rotation protrusion 2111 formed on one side thereof and a second rotation protrusion 2112 formed on the other side thereof. The link member 221 may include a first link 2211 into which the first rotation protrusion 2111 is inserted on one side thereof and a second link 2212 into which the second rotation protrusion 2112 is inserted on the one side thereof. In particular, the first link 2211 may include a first guide groove 2211a formed longitudinally.

The drive module 220 may include a fixed bracket 223 formed to rotatably couple the other side of the first link 2211 and the other side of the second link 2212. The fixed bracket 223 may include a guide plate 2231 into which the first rotation protrusion 2111 is inserted. In particular, the guide plate 2231 may include a second guide groove 2231a formed to guide the curved movement of the support bracket 211.

The drive module 220 may include a rotation plate 225. The rotation plate 225 is formed by extending from a rotation shaft 224 coupled to the other side of the first link 2211 and the outer peripheral surface of the rotation shaft 224. In addition, the rotation plate 225 is coupled to the ball screw member 222. A second rotation shaft 228 may be coupled to the other side of the second link 2212. Therefore, a pair of link members 221 may be rotated simultaneously through the rotation shaft 224.

The ball screw member 222 may include a drive motor 2221, a ball screw bolt 2222, and a ball screw nut 2223. The ball screw bolt 2222 rotates when driven by the drive motor 2221, and the ball screw nut 2223 moves linearly due to the rotation of the ball screw bolt 2222. In this case, the rotation plate 225 may be rotatably coupled to the ball screw nut 2223. Therefore, as the ball screw nut 2223 moves in a straight line, the rotation plate 225 may rotate with the rotation shaft 224, enabling the rotation of the first link 2211.

Additionally, the display device 200 according to the embodiment of the present disclosure may include a position detection sensor 226 that detects the height of the front display 210. The drive module 220 may include a detection plate 227 that extends from the outer peripheral surface of the rotation shaft 224 at a position corresponding to the position detection sensor 226.

Hereinafter, a method of operating the components included in the display device 200 according to the embodiment of the present disclosure will be described in more detail.

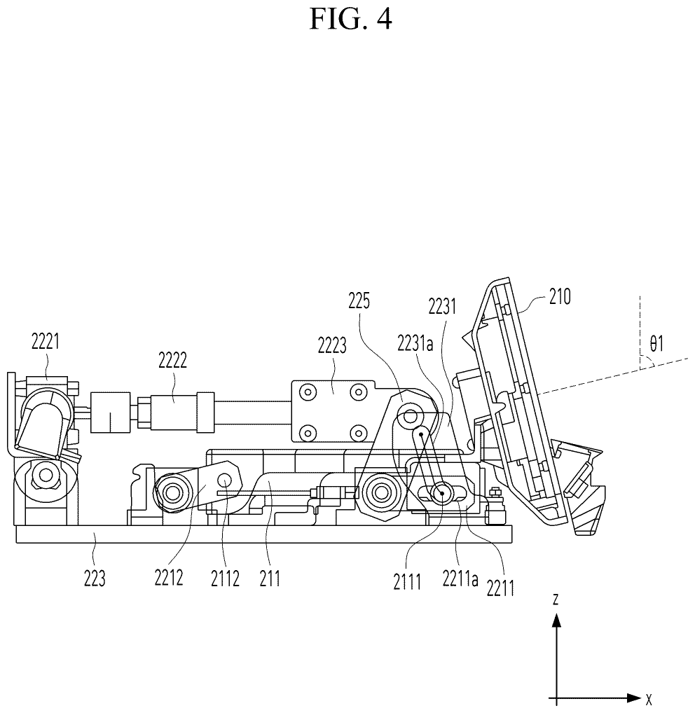

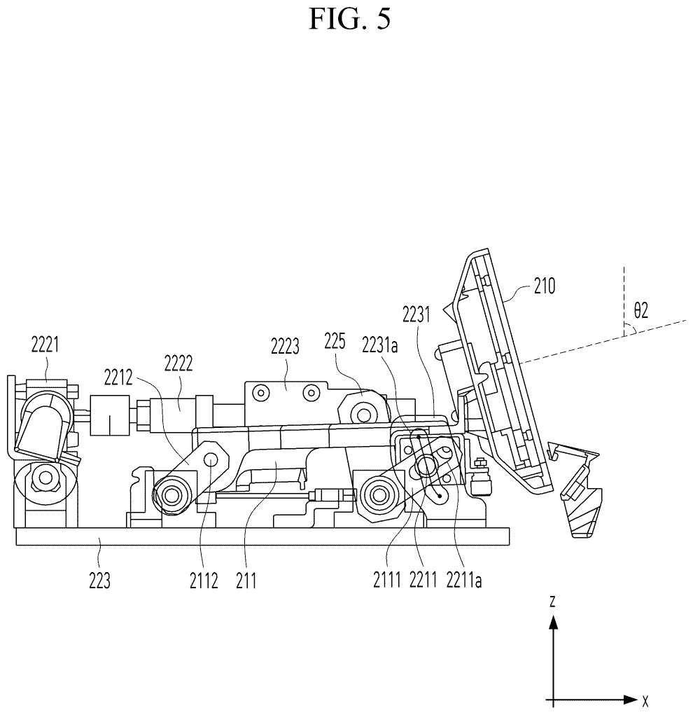

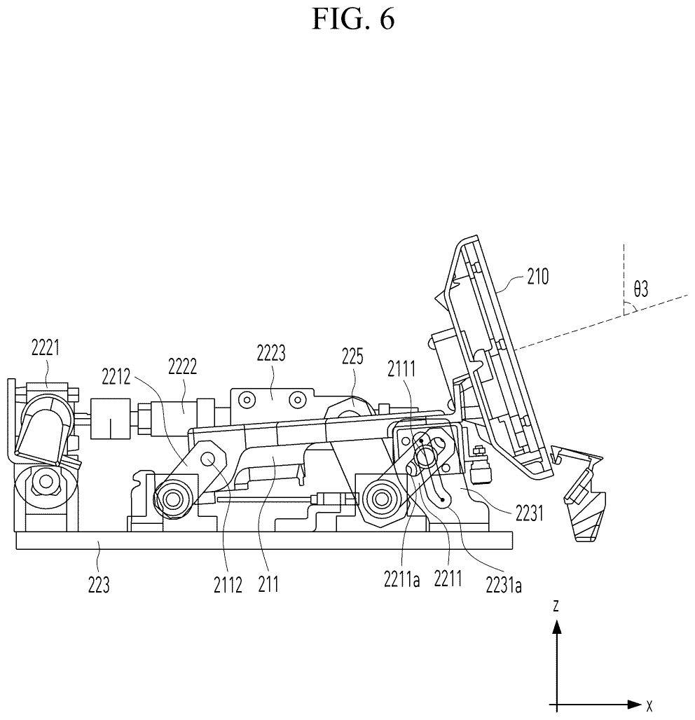

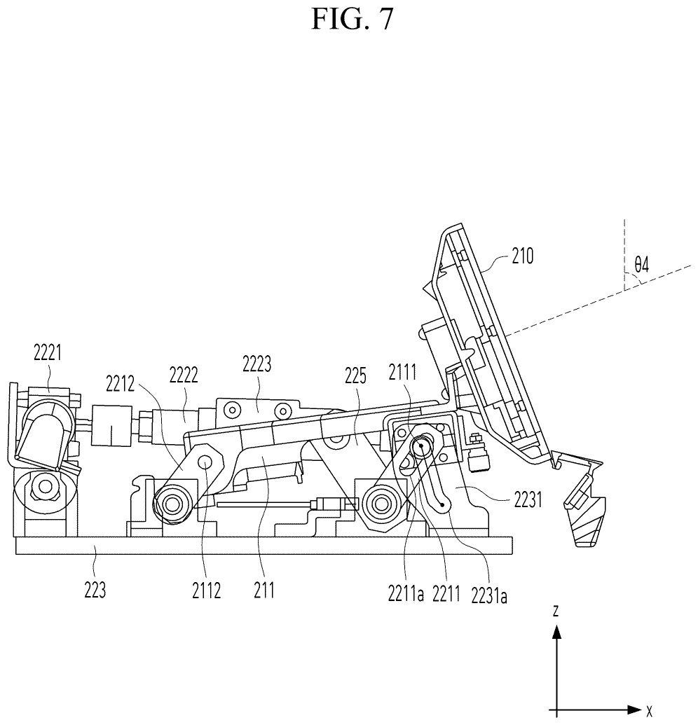

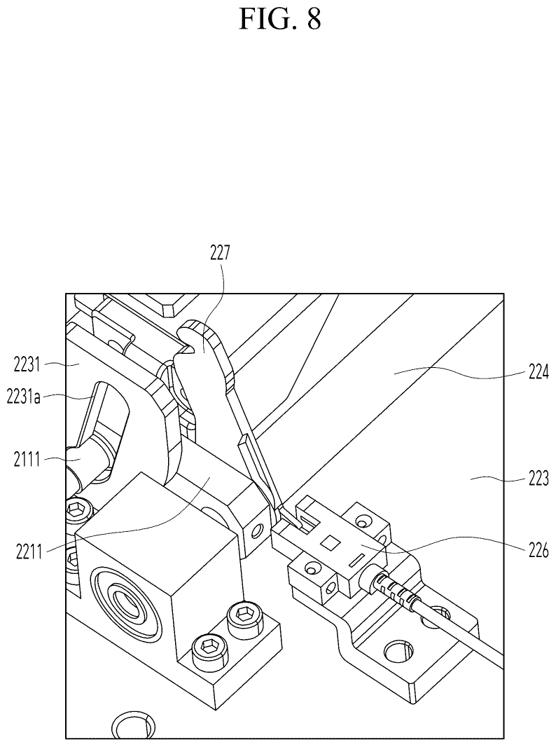

FIGS. 4 to 7 are diagrams for explaining a method of adjusting the height of a front display 210 in a display device 200 according to an embodiment of the present disclosure. FIG. 8 is a diagram for explaining a method of detecting the height of a front display 210 through a position detection sensor 226 in a display device 200 according to the embodiment of the present disclosure.

Specifically, FIGS. 4 to 7 show that the height of the front display 210 is adjusted by the operation of a drive module 220 and the height of the front display 210 changes from the lowest point to the highest point.

FIG. 4 shows a case where the height of the front display 210 is at the lowest point, and in this case, the front view of a driver or passenger may be maximized. In this state, the height of the front display 210 may be adjusted depending on the position of a specific facial portion of the driver through the camera 140 described above in FIG. 3.

Specifically, a ball screw bolt 2222 may rotate by the operation of a drive motor 2221. A ball screw nut 2223 may move in a straight line by the rotation of the ball screw bolt 2222. A rotation plate 225 extending from the outer peripheral surface of a rotation shaft 224 may be rotatably coupled to the side of the ball screw nut 2223. Thus, when the ball screw nut 2223 moves linearly, the rotation plate 225 may rotate together with the rotation shaft 224.

A support bracket 211, which is coupled to the rear surface of the front display 210, may be rotatably coupled to one side of a first link 2211. The rotation shaft 224 may be coupled to the other side of the first link 2211. In addition, the other side of the first link 2211 may be rotatably coupled to a fixed bracket 223.

A first rotation protrusion 2111 formed on one side of the support bracket 211 may be inserted into a first guide groove 2211a formed on the first link 2211. The fixed bracket 223 may include a guide plate 2231 into which the first rotation protrusion 2111 is inserted.

A second rotation protrusion 2112 may be formed on the other side of the support bracket 211. The second rotation protrusion 2112 may be inserted into one side of a second link 2212. The other side of second link 2212 may be rotatably coupled to the fixed bracket 223.

In particular, the first link 2211 may include the first guide groove 2211a formed longitudinally at one side thereof. The first rotation protrusion 2111 may be inserted into the first guide groove 2211a. The guide plate 2231 may include a second guide groove 2231a having a curved shape. The first rotation protrusion 2111 is inserted into the second guide groove 2231a.

Therefore, the rotation of the ball screw bolt 2222 and the linear movement of the ball screw nut 2223 are driven by the drive motor 2221. The rotation of the ball screw bolt 2222 and the linear movement of the ball screw nut 2223 may rotate the first link 2211 and the second link 2212, enabling the support bracket 211 to move and thus adjusting the height of the front display 210.

In particular, as described above, while the front display 210 is moving, the front display 210 also needs to rotate to align with the position of the specific facial portion of the driver. In other words, to align with the position of the specific facial portion of the driver, the angles of θ1, θ2, θ3, and θ4 shown in FIGS. 4 to 7 may all be different. The angles of θ1, θ2, θ3, and θ4 may be associated with the movement of the ball screw nut 2223.

In addition, due to the structure in which the front display 210 is inserted and mounted into the mounting portion 120 of the vehicle 100 described above, it is necessary to protect a front lower part of the front display 210 while the front display 210 is moving.

To this end, the display device 200 according to the embodiment of the present disclosure may enable the front display 210 to rotate and move in a curved path during the movement of the front display 210. This may be implemented through the second guide groove 2231a, which is formed with a curved shape in the guide plate 2231, and the first guide groove 2211a, which is formed longitudinally at one end of the first link 2211.

That is, the first rotation protrusion 2111 formed on the support bracket 211 may be inserted into the first guide groove 2211a and the second guide groove 2231a, allowing the support bracket 211 to rotate and move in a curved path when the first link 2211 rotates.

Therefore, in the display device 200 according to the embodiment of the present disclosure, the drive module 220 may adjust the height of the front display 210 through a four-bar linkage structure involving four rotation points formed on the first link 2211, second link 2212, and support bracket 211.

Additionally, the front display 210 may rotate and move in a curved path to align with the specific facial portion of the driver and to protect the front lower part of the front display 210.

Referring to FIG. 8, in the display device 200 according to the embodiment of the present disclosure, a drive module 220 may include the position detection sensor 226 that detects the height of the front display 210.

In an embodiment, the position detection sensor 226 may be located at the top of a fixed bracket 223. The drive module 220 may include a detection plate 227 extending from the outer peripheral surface of a rotation shaft 224 at a position corresponding to the position detection sensor 226. Therefore, the detection plate 227 may rotate together with the rotation shaft 224, and the position detection sensor 226 may detect the height of the front display 210 by detecting a change in the position depending on the rotation of the detection plate 227.

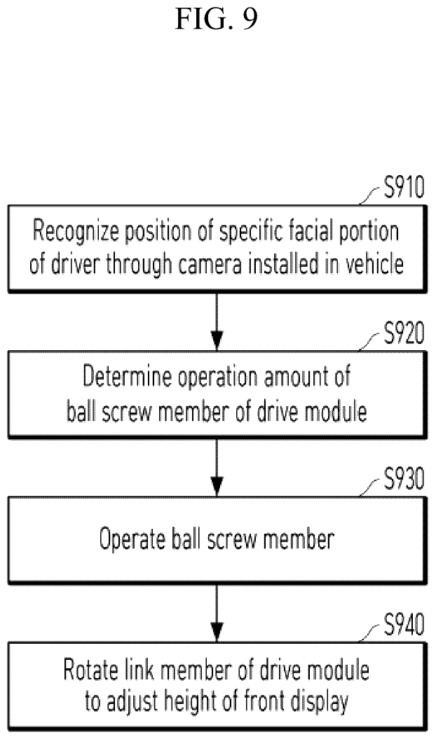

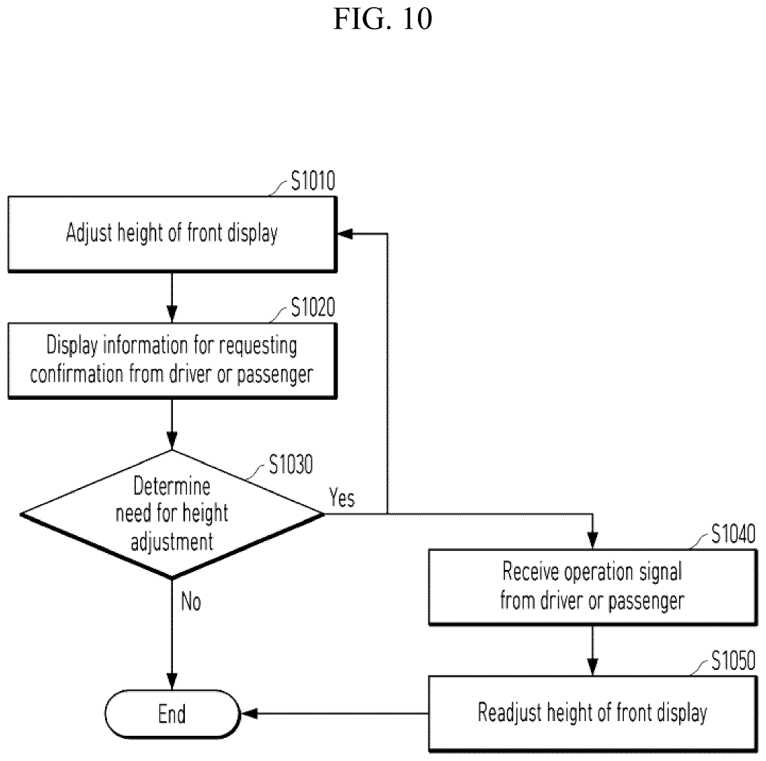

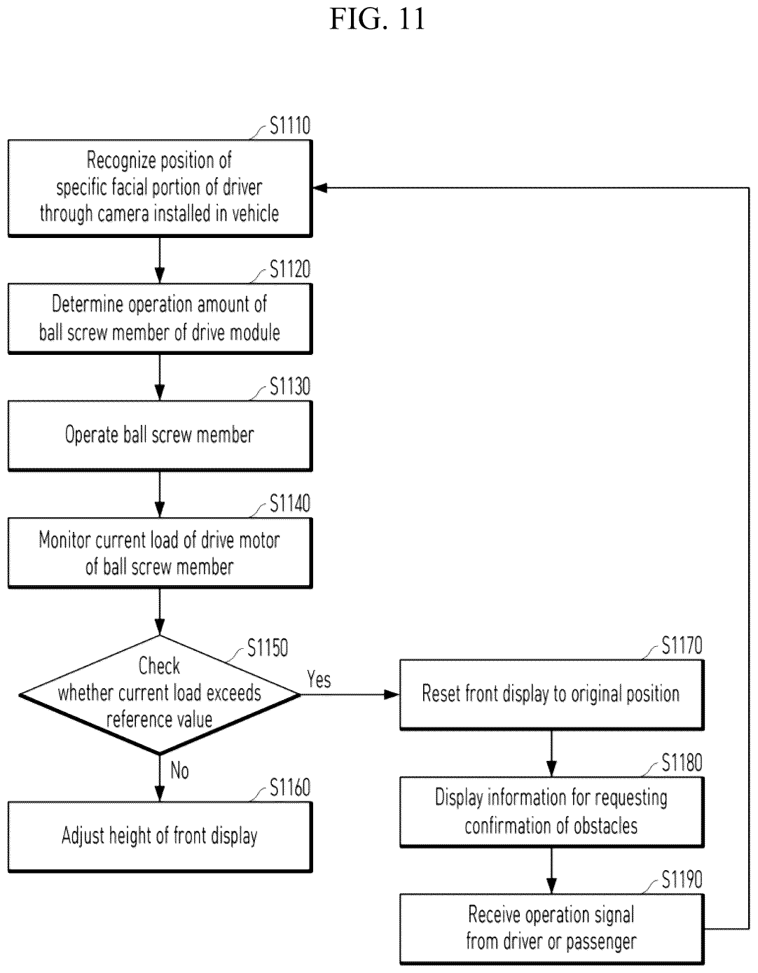

FIG. 9 is a diagram for explaining a method of controlling a display device according to an embodiment of the present disclosure. FIGS. 10 and 11 are diagrams for explaining various embodiments of a display device control method according to the present disclosure.

Hereinafter, the display device control method according to the embodiment of the present disclosure will be described based on the content described above with reference to FIGS. 1 to 8.

In the display device control method according to the embodiment of the present disclosure, the position of a specific facial portion of a driver may be recognized through a camera 140 mounted on a vehicle 100 (S910). Then, the operation amount of a ball screw member 222 of a drive module 220 may be determined based on the recognized position of the specific facial portion (S920). Here, the operation amount of the ball screw member 222 may refer to the movement amount of a ball screw nut 2223 when the ball screw nut 2223 moves in a straight line. Accordingly, the rotation amount of the ball screw bolt 2222 through the operation of a drive motor 2221 may be determined.

Through the operation of the ball screw member 222 (S930), a link member 221 of the drive module 220 may rotate, thereby adjusting the height of a front display 210 (S940). In particular, the display device control method according to the embodiment of the present disclosure may adjust the height of the front display 210 to align with the position of the specific facial portion of the driver and control the front display 210 to rotate and move in a curved path to protect a front lower part of the front display 210.

FIG. 10 is a diagram for explaining another embodiment of the display device control method according to the present disclosure.

After adjustment of the height of a front display 210 (S1010), information for requesting confirmation from a driver or passenger may be displayed (S1020). The information for requesting confirmation from the driver or passenger may be displayed on the screen of the front display 210, and the displayed information for requesting confirmation may include, for example, whether adjustment of the height of the front display 210 is necessary as shown in FIG. 10 (S1030).

If the driver or passenger determines that the height adjustment is not necessary, the adjusted height of the front display 210 may be maintained. On the other hand, if the driver or passenger determines that the height adjustment is necessary, an operation signal from the driver or passenger may be received (S1040). The operation signal from the driver or passenger may include, for example, adjusting the height of the front display 210 through a touch on the screen of the front display 210. In addition, based on the operation signal from the driver or passenger, the height of the front display 210 may be readjusted (S1050).

Alternatively, the displayed information for requesting confirmation may include information for proceeding to the step of adjusting the height of the front display 210 (S1010). The driver or passenger may initiate the height adjustment step (S1010) again by touching the screen of the front display 210.

FIG. 11 is a diagram for explaining a further embodiment of the display device control method according to the present disclosure.

After recognizing the position of a specific facial portion of a driver through a camera 140 mounted on a vehicle 100 (S1110), the operation amount of a ball screw member 222 of a drive module 220 may be determined depending on the position of the recognized specific facial portion (S1120). The ball screw member 222 may operate based thereon (S1130).

In this case, a current load of the drive motor 2221 of the ball screw member 222 may be monitored (S1140), and it may be determined whether the monitored current load exceeds a reference value (S1150). This is because, if the operation of the drive module 220 is obstructed by obstacles, it may lead to damage of the display device 200. If the monitored current load does not exceed the reference value, the operation of the ball screw member 222 may continue, allowing the height of a front display 210 to be adjusted (S1160).

On the other hand, if the monitored current load exceeds the reference value, that is, if the operation of the drive module 220 is obstructed by obstacles, the front display 210 may be returned to the original position (S1170). Thereafter, information for requesting confirmation of obstacles may be displayed (S1180). The information for requesting confirmation of obstacles may be displayed on the screen of the front display 210. In addition, an operation signal from the driver or passenger may be received (S1190).

The operation signal from the driver or passenger may be received, for example, through a touch on the screen of the front display 210. After removing any obstacles that obstruct the operation of the drive module 220, the driver or passenger may send the operation signal to enable the drive module 220 to operate again through the touch on the screen of the front display 210. Thereafter, the display device control method may return to the step of recognizing the position of the specific facial portion of the driver through the camera 140 mounted on the vehicle 100 (S1110).

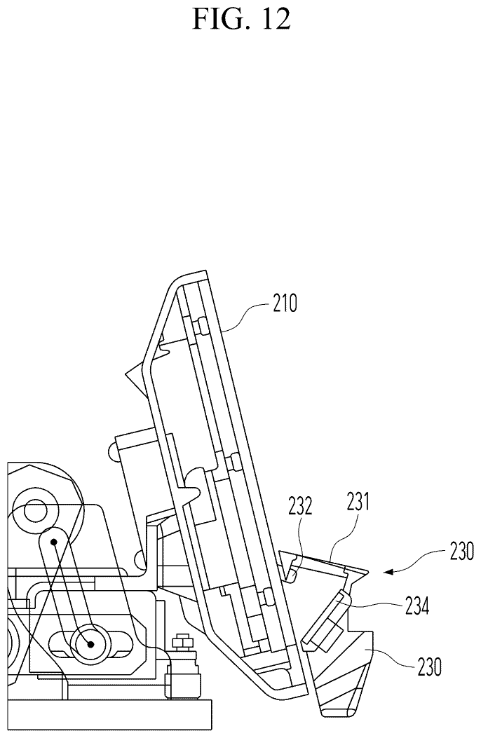

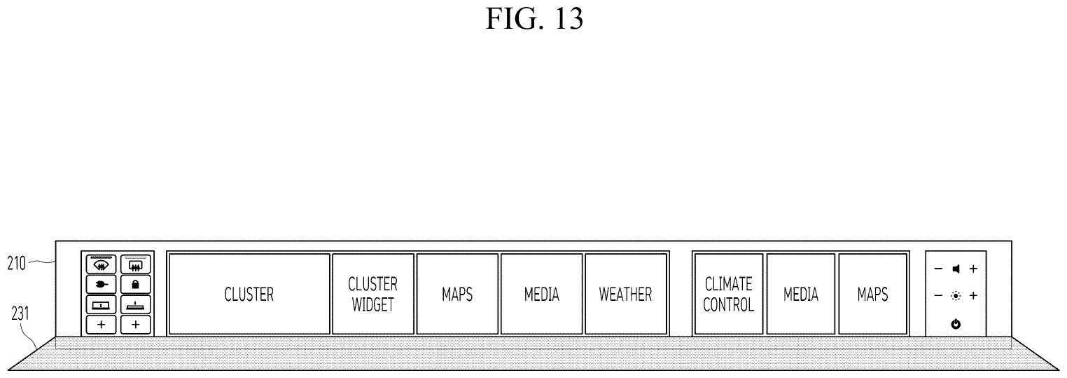

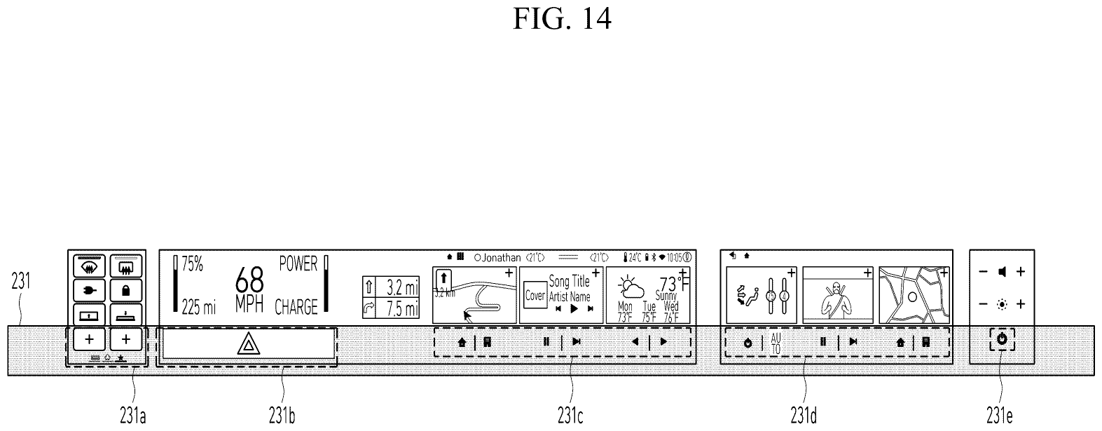

FIG. 12 is a diagram illustrating a see-through module 230 in a display device 200 according to an embodiment of the present disclosure. FIG. 13 is a diagram illustrating a see-through panel 231 in a display device 200 according to an embodiment of the present disclosure. FIG. 14 is a diagram illustrating information provided to a see-through panel 231 in a display device 200 according to an embodiment of the present disclosure.

Referring to FIGS. 4 and 12 together, the display device 200 according to the embodiment of the present disclosure may include the see-through module 230 that is in close contact with a front lower part of a front display 210 when the front display 210 is positioned at the lowest point.

The see-through module 230 may include a see-through panel 231 configured to provide information to a driver and a passenger by transmitting light from a lower area of the front display 210. In addition, the see-through module 230 may include a rubber member 232 coupled to one end of the see-through panel 231.

The rubber member 232 may be in contact with the front lower part of the front display 210 and serve to block light from leaking through a gap between the see-through panel 231 and the front lower part of the front display 210. In other words, it is possible to form a darkroom to create a see-through area through the rubber member 232, which may make the information provided through the see-through panel 231 appear clearer to the driver and passenger.

As described above, in the display device 200 according to the embodiment of the present disclosure, the front display 210 moves in a curved path and rotates while the height thereof is adjusted, which may minimize interference with the see-through module 230.

In the display device 200 according to the embodiment of the present disclosure, the see-through module 230 may include a housing 233 coupled to the see-through panel 231 and a reflector 234 located inside the housing 233, positioned opposite the front lower part of the front display 210, and configured to reflect light. The reflector 234 may include a reflective surface made of a thin metal film including aluminum. The reflector 234 may be positioned at an appropriate angle inside the housing 233 such that light from the lower area of the front display 210 is reflected and transmitted through the see-through panel 231.

Referring to FIGS. 12 to 14 together, in the display device 200 according to the embodiment of the present disclosure, the front display 210 may include a plurality of display areas. As described above, the plurality of display areas may provide convenience to passengers by offering driving-related information, maps, media, and weather-related applications.

In the display device 200 according to the embodiment of the present disclosure, when the height of the front display 210 is at the lowest point, the forward view of the driver or passenger may be maximized as described above in FIG. 4. In this case, light from the lower area of the front display 210 may be transmitted through the see-through panel 231, thereby providing various information 231a, 231b, 231c, 231d, and 231e to the driver and passenger.

The information provided through the see-through panel 231 may correspond to information displayed in the plurality of display areas at the top of the front display 210. The information provided through the see-through panel 231 may be a simplified version of the information displayed at the top of the front display 210. The simplified information refers to information capable of being implemented at a lower resolution than the information displayed at the top of the front display 210, information capable of being displayed with a small amount of data, or a combination thereof.

In the display device 200 according to the embodiment of the present disclosure, the see-through panel 231 may also serve a role for the interior design of the vehicle 100. Additionally, various colors of light related to information on the driving of the vehicle 100 may be transmitted through the see-through panel 231 to provide the driving information to the driver or passenger.

In summary, the display device and vehicle equipped with the same according to the present disclosure may provide information to the driver and passenger by transmitting light from the lower area of the front display through the see-through area. In addition, the display device and vehicle equipped with the same according to the present disclosure may adjust the height of the display depending on the position of a specific facial portion of the driver, thereby effectively providing various convenience information. Moreover, the display device and vehicle equipped with the same according to the present disclosure may efficiently control the movement and tilting of the display through the drive module including the ball screw member and the link member. Further, the display device and vehicle equipped with the same according to the present disclosure may organically control the movement of the display through a four-bar linkage structure involving four rotation points formed on the first link, second link, and support bracket.

The above detailed description is to be construed in all aspects as illustrative and not restrictive. The scope of the present disclosure should be determined by reasonable interpretation of the appended claims and all changes coming within the equivalency range of the present disclosure are intended to be embraced in the scope of the present disclosure.

What is claimed is:

1. A display device including a see-through area for a vehicle, the display device comprising:
a front display having a plurality of display areas and located in front of a driver seat and a passenger seat of the vehicle;
a drive module configured to adjust a position of the front display; and
a see-through module adjacent to a front lower part of the front display when the front display is located at a lowest point,
wherein the see-through module comprises a see-through panel configured to provide information to a driver and a passenger by transmitting light from a lower area of the front display.

2. The display device of claim 1,
wherein the see-through module further comprises a rubber member coupled to a first end of the see-through panel, and
wherein the rubber member is in contact with the front lower part of the front display and configured to block light from leaking through a gap between the see-through panel and the front lower part of the front display.

3. The display device of claim 2, wherein the see-through module further comprises:
a housing coupled to the see-through panel; and
a reflector located inside the housing, positioned opposite the front lower part of the front display, and configured to reflect light transmitted from a lower area of the front display.

4. The display device of claim 3, wherein the reflector comprises a reflective surface made of a thin metal film, the thin metal film including aluminum.

5. The display device of claim 1, wherein the drive module is linked to a camera mounted on the vehicle, and
wherein the drive module is configured to:
adjust the position of the front display based on a position of a specific facial portion of an occupant in the driver seat or the passenger seat; and
provide driving force to the front display to enable the front display to rotate and move in a curved path.

6. The display device of claim 5, further comprising:
a support bracket coupled to a rear surface of the front display,
wherein the drive module comprises:
a link member rotatably coupled to the support bracket; and
a ball screw member connected to the link member and configured to move in a straight line and rotate the link member.

7. The display device of claim 6, wherein the support bracket comprises:
a first rotation protrusion formed on a first side thereof; and
a second rotation protrusion formed on a second side thereof, and
wherein the link member comprises:
a first link into which the first rotation protrusion is inserted on a first side thereof, the first link comprising a first guide groove formed longitudinally; and
a second link into which the second rotation protrusion is inserted on the first side thereof.

8. The display device of claim 7,
wherein the drive module comprises a fixed bracket formed to rotatably couple a second side of the first link and a second side of the second link,
wherein the fixed bracket comprises a guide plate into which the first rotation protrusion is inserted, and
wherein a second guide groove configured to guide a curved movement of the support bracket is formed on the guide plate.

9. The display device of claim 8, wherein the drive module further comprises:
a rotation shaft coupled to the second side of the first link; and
a rotation plate extending from an outer peripheral surface of the rotation shaft and coupled to the ball screw member.

10. The display device of claim 1, wherein the position of the front display comprises a height of the display.

11. The display device of claim 5, wherein the position of the specific facial portion of the occupant in the driver seat or the passenger seat is detected by the camera.

12. A vehicle comprising:
a vehicle body;
a mounting portion located on the vehicle body; and
a display device mounted on the mounting portion and configured to provide a see-through area,
wherein the display device comprises:
a front display having a plurality of display areas and located in front of a driver seat and a passenger seat of the vehicle;
a drive module configured to adjust a height of the front display; and
a see-through module adjacent to a front lower part of the front display when the front display is located at a lowest point, and
wherein the see-through module comprises a see-through panel configured to provide information to a driver and a passenger by transmitting light from a lower area of the front display.

13. A display system for a vehicle, the system comprising:
a front display having a plurality of display areas and located in front of a driver seat and a passenger seat of the vehicle;
a camera configured to detect a position of a specific facial portion of an occupant in the driver seat or the passenger seat;
a drive module in communication with the camera configured to adjust a position of the front display;
a see-through module comprising a reflector and a see-through panel, the see-through panel positioned adjacent to a front lower part of the front display when the front display is located at a lowest point, such that light from the lower area of the front display is reflected by the reflector and transmitted through the see-through panel to provide information to the occupant; and
a processor configured to control the drive module to adjust the position of the front display based on the detection of the position of the specific facial portion of the occupant by the camera.

14. The system of claim 13, wherein the processor is further configured to control the drive module to adjust the position of the front display to provide optimal viewing by the occupant.

15. The system of claim 13, wherein the see-through module is movable between:
a first position in which the see-through module is adjacent to the front lower part of the front display to reflect light from the lower part of the front display through the see-through panel, and
a second position in which the see-through module is positioned away from the front lower part of the front display such that light from the lower part of the front display is not reflected through the see-through panel.
